(19) United States
(12) Patent Application Publication
(10) Pub. No.: US 2018/0301068 A1
(43) Pub. Date: Oct. 18, 2018

(54) OXIDATIONRESISTANT GLASS-MOUNTED PHOTOGRAPH AND METHOD FOR MANUFACTURING SAME

(71) Applicant: HON HAI PRECISION INDUSTRY CO., LTD., New Taipei (TW)

(72) Inventors: FENG-YUEN DAI, New Taipei (TW); JIH-CHEN LIU, New Taipei (TW); CHIH-JUNG CHANG, New Taipei (TW); HUNG-CHUN MA, New Taipei (TW); HAN-LUNG LEE, New Taipei (TW); HAN-LUNG CHAO, New Taipei (TW); YU-LIN LIAO, New Taipei (TW); CHEN-CHU CHIANG, New Taipei (TW); WEI-TING CHEN, New Taipei (TW); JAN-WAN CHANG, New Taipei (TW)

(21) Appl. No.: 15/668,940

(22) Filed: Aug. 4, 2017

(30) Foreign Application Priority Data
Apr. 12, 2017 (TW) 106112154

(51) Int. Cl. G09F 7/00; G09F 23/00; B05D 1/02; C03C 17/34; C03C 17/00; B41J 2/01; B41J 3/407

(52) U.S. Cl. CPC G09F 7/00; G09F 23/00; B05D 1/02; C03C 17/3405; C03C 2218/119; B41J 2/01; B41J 3/407; C03C 2217/72; C03C 17/007

(57) ABSTRACT

A method for manufacturing an oxidation-resistant glass-mounted photograph includes steps of providing a transparent base, the transparent base includes a front surface and a rear surface opposite to the front surface. A UV inkjet printer sprays UV-curable glue onto the rear surface of the transparent base to form a bonding layer, and an electronic file of a pattern layer is installed into the UV inkjet printer, a layer of UV-curable ink on the bonding layer is printed on the bonding layer using the UV inkjet printer according to the electronic file of the pattern layer. The layer of UV-curable ink is cured to form the pattern layer providing a representation of a desired image.

### FIELD

The subject matter herein generally relates to ornamental photo display, in particular to oxidation-resistant glass-mounted photograph and method for manufacturing same.

### BACKGROUND

A method for manufacturing an oxidation-resistant glass-mounted photograph comprises steps of providing a glass; coating thereon a layer of adhesive, and adhering a paper-based photograph on the glass by the layer of adhesive. However, the adhesive layer inside the oxidation-resistant glass-mounted photograph is easily oxidized in the air and become yellow, thereby reducing the ornamental quality.

### BRIEF DESCRIPTION OF THE DRAWINGS

Implementations of the present technology will now be described, by way of example only, with reference to the attached figures.

FIG. 1 is an isometric view of an oxidation-resistant glass-mounted photograph in accordance with a first exemplary embodiment.

FIG. 2 is a cross-sectional view of the glass mounted photograph of FIG. 1.

FIG. 3 is a cross-sectional view of a second exemplary embodiment of the glass-mounted photograph.

FIG. 4 is a flowchart of a method for manufacturing the oxidation-resistant glass-mounted photograph of FIG. 1.

FIG. 5 is an isometric view of a UV inkjet printer being used for manufacturing the oxidation-resistant glass-mounted photograph of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein can be practiced without these specific details. In other instances, methods, procedures, and components have not been described in detail so as not to obscure the related relevant feature being described. Also, the description is not to be considered as limiting the scope of the exemplary embodiments described herein. The drawings are not necessarily to scale and the proportions of certain parts may be exaggerated to better illustrate details and features of the present disclosure.

Several definitions that apply throughout this disclosure will now be presented.

The term “substantially” is defined to be essentially conforming to the particular dimension, shape, or other feature that the term modifies, such that the component need not be exact. For example, “substantially cylindrical” means that the object resembles a cylinder, but can have one or more deviations from a true cylinder. The term “comprising,” when utilized, means “including, but not necessarily limited to”; it specifically indicates open-ended inclusion or membership in the so-described combination, group, series, and the like. The references “a plurality of and “a number of mean “at least two.”

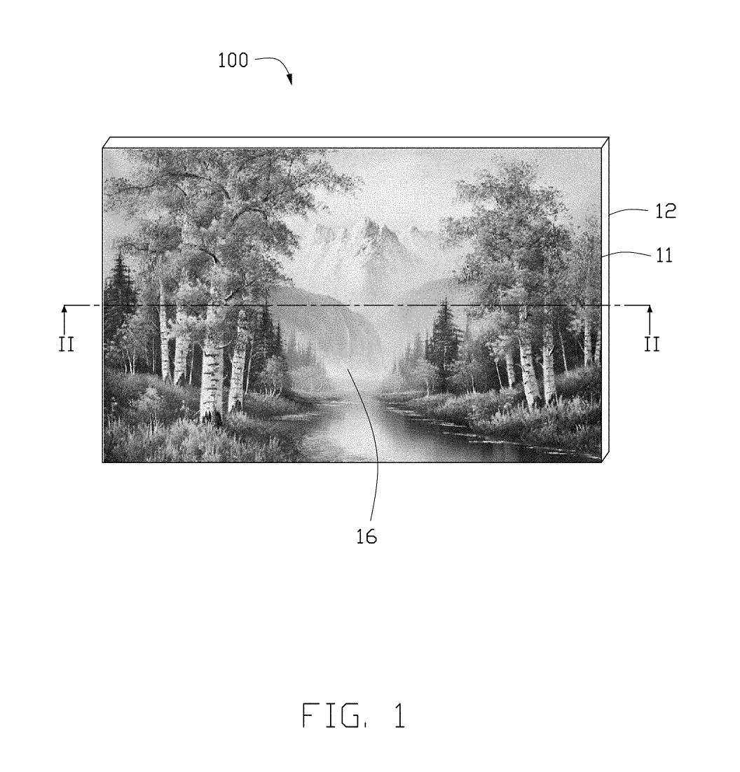

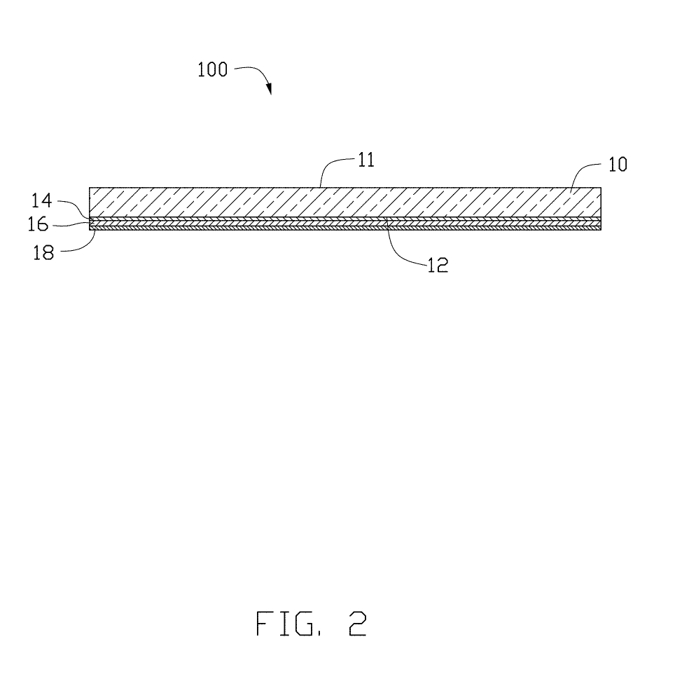

FIGS. 1-2 illustrate an oxidation-resistant glass-mounted photograph 100 according to an exemplary embodiment. The oxidation-resistant glass-mounted photograph 100 includes a transparent base 10, a bonding layer 14, a pattern layer 16, and a coating layer 18. The term “glass-mounted photograph 100” includes any finished design or pattern resembling an actual photograph.

The transparent base 10 is reinforced glass or acrylic material. Reinforced glass is not easily broken. Acrylic material has advantages of light weight, high transparency, and easy machining. The transparent base 10 can be a simple shape, such as prismatic shape, spherical shape, or cylindrical shape, and also can be a complicated shape, such as that of the human form, animal shape, flower shape, or bird shape. The transparent base 10 includes a front surface 11 and a rear surface 12 opposite to the front surface 11.

The bonding layer 14 is formed on the rear surface 12. The bonding layer 14 is configured to increase adhesion between the pattern layer 16 with the transparent base 10, to prevent the pattern layer 16 from falling off the transparent base 10. The bonding layer 14 is made of transparent and colorless material, such as ultraviolet-curable glue (UV glue). A thickness range of the bonding layer 14 is about 5 micrometers to about 50 micrometers, preferably is about 5 micrometers.

The pattern layer 16 is formed on the bonding layer 14. A thickness range of the pattern layer 16 is from about 5 micrometers to about 50 micrometers. The pattern layer 16 is a photograph or facsimile of a photograph and is formed by spraying ultraviolet-curable ink (UV ink) on the surface of the bonding layer 14, and curing the UV ink on the surface of the bonding layer 14. That is, the pattern layer 16 is a UV ink layer.

The pattern layer 16 can be a portrait, a landscape scene, an animal picture, auspicious image, graining pattern, leather pattern, or 3D image. Colors of the pattern layer 16 can be single color or color combinations. In this exemplary embodiment, the pattern layer 16 is a 2D image, covering all of the bonding layer 14.

The coating layer 18 is formed on the pattern layer 16. The coating layer 18 is transparent and colorless and configured to protect the pattern layer 16, to protect the pattern layer 16 from scratches. The coating layer 18 can be made of rigid resin, such as acrylic glass or polymethylmethacrylate (PMMA). A thickness range of the coating layer 18 is about 5 micrometers to about 50 micrometers, preferably is about 10 micrometers.

In this exemplary embodiment, the coating layer 18 is composed of acrylic, titanium dioxide, and additives and the coating layer 18 is mixed at certain proportions under room temperature, and the coating layer 18 is able to enhance surface atomization. In a preferred exemplary embodiment, the additives comprise a dispersing agent, defoaming agent, photosensitizer, and light stabilizer, and proportions is represented by the weight ratios of the acrylic, titanium dioxide, and antioxidant, which are respectively 65%˜75%, 15˜20%, and 5˜15%.

The pattern layer 16 in the oxidation-resistant glass-mounted photograph 100 is formed by spraying UV ink on the bonding layer 14 and protected by the coating layer 18, thereby the pattern layer 16 has an advantage of permanent preservation and never turning yellow.

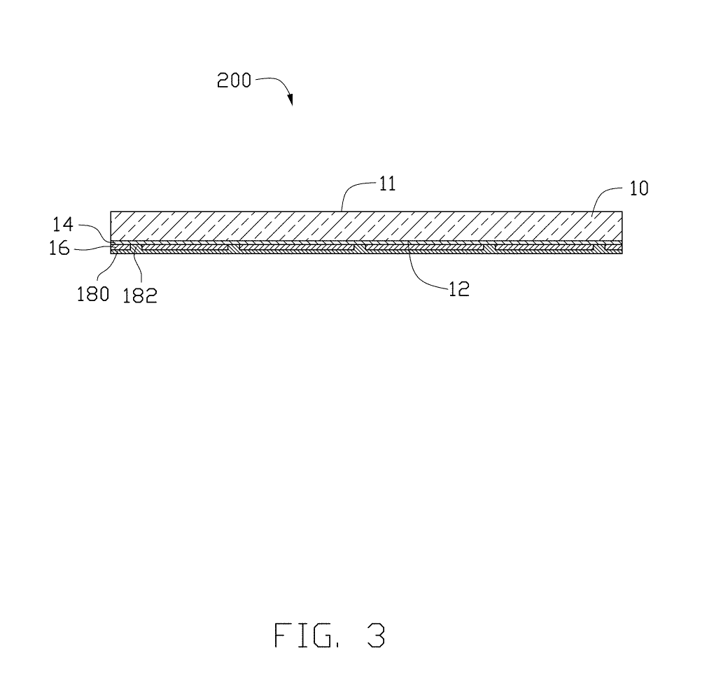

FIG. 3 illustrates an oxidation-resistant glass-mounted photograph 200 according to a second exemplary embodiment. The photograph 200 is similar to the photograph 100 in FIG. 2. The difference between the photograph 200 and the photograph 100 in FIG. 1 is that the pattern layer 160 in oxidation-resistant glass-mounted photograph 200 is a 3D image, and defines a plurality of pattern gaps 162 therein, and the coating layer 18 is filled into the pattern gaps 162.

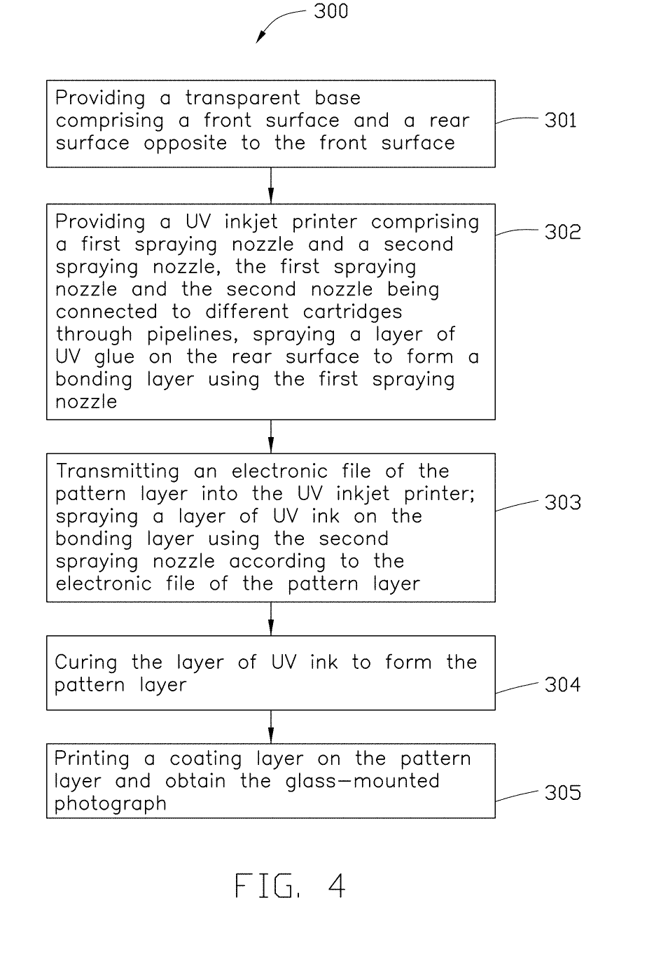

FIG. 4 illustrates a flowchart in accordance with a third exemplary embodiment. The example method 300 for manufacturing the oxidation-resistant glass-mounted photograph 100 (shown in FIG. 1) is provided by way of an example, as there are a variety of ways to carry out the method. Additionally, the illustrated order of blocks is by example only and the order of the blocks can change or be omitted. The method 300 can begin at block 301.

At block 301, a transparent base 10 is provided, the transparent base 10 includes a front surface 11 and a rear surface 12 opposite to the front surface 11, and the rear surface is cleaned. The transparent base 10 is made from reinforced glass or acrylic material. Reinforced glass is not easily broken. Acrylic material has advantages of light weight, high transparency, and easy machining.

The rear surface 12 is processed to form a hardened coating layer (not shown) there on. A hardness of the transparent base 10 can reach up to about 5-6H, which can improve wear scratch resistant, transparency, and has a good finish.

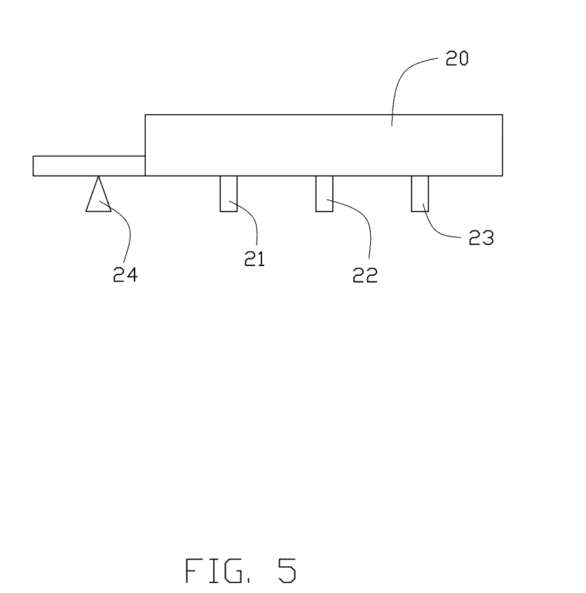

At block 302, a UV inkjet printer 20 is provided, and a bonding layer 14 is formed on the rear surface using the UV inkjet printer 20, as shown in FIG. 5, the UV inkjet printer 20 includes a first spraying nozzle 21, a second spraying nozzle 22, a third spraying nozzle 23 and a UV source 24 mounted at one side on the UV inkjet printer 20. The first spraying nozzle 21, the second spraying nozzle 22, and the third spraying nozzle 23 are connected to different cartridges through pipelines. The bonding layer 14 is made from UV (ultraviolet) glue. Spray a layer of UV glue on the rear surface 12 to form the bonding layer 14 using the first spraying nozzle 21. The bonding layer 14 is configured to increase a contact force between the pattern layer 16 with the transparent base 10, to prevent the pattern layer 16 from falling off the transparent base 10.

At block 303, an electronic file (not shown) of the pattern layer 16 is transmitted into the UV inkjet printer 20, a layer of UV ink is printed on the bonding layer 14 using the second spraying nozzle 22 according to the electronic file of the pattern layer 16, and cured by a UV light emitted from the UV source 24. Thereby, the pattern layer 16 is adhered on the transparent base 10 firmly by the bonding layer 14.

The electronic file of the pattern layer 16 is transmitted into the UV inkjet printer using blue tooth transmission, Wi-Fi transmission or USB transmission or other types of data transmission but not limited to the examples provided herein. The UV inkjet printer 20 prints an layer of ink on the bonding layer 14 to form the pattern layer 16 according to the electronic file. Colors of the pattern layer 16 can be single color or color combinations. The pattern layer 16 can be a portrait, landscape, animal, auspicious pattern, graining pattern, leather pattern, or 3D image.

At block 304, the UV source 24 is applied to cure the UV ink on the bonding layer 14, and a curing time is about 3-5 seconds, and then, the ink is firmly adhered on the transparent base and formed the pattern layer 16.

At block 305, a coating layer 18 is printed on the pattern layer 16 by the third spray nozzle 23, thereby, the oxidation-resistant glass-mounted photograph 100 is obtained. The coating layer 18 is configured to prevent the pattern layer 16 from scratches. The coating layer 18 can be made of rigid resin, such as acrylic glass or polymethylmethacrylate (PMMA). A thickness range of the coating layer 18 is about 5 micrometers to about 50 micrometers, is preferably, about 10 micrometers.

In this exemplary embodiment, the coating layer 18 is composed of acrylic, titanium dioxide and additives and is mixed at a certain proportion under room temperature. In a preferred exemplary embodiment, the proportion is the weight ratio of the acrylic, titanium dioxide, and antioxidant, and the weight ratio are respectively 65%˜75%, 15˜20%, 5˜15%.

The exemplary embodiments shown and described above are only examples. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims. It will therefore be appreciated that the exemplary embodiments described above may be modified within the scope of the claims.

What is claimed is:

1. An oxidation-resistant glass-mounted photograph, comprising:
a transparent base comprising a front surface and a rear surface opposite to the front surface;
a transparent bonding layer formed on the rear surface, and a pattern layer formed on the transparent bonding layer, and the pattern layer being made from UV curing ink.

2. The oxidation-resistant glass-mounted photograph of claim 1, wherein the transparent base is made from reinforced glass or acrylic material.

3. The oxidation-resistant glass-mounted photograph of claim 1, further comprising a coating layer formed on the printing pattern layer.

4. The oxidation-resistant glass-mounted photograph of claim 3, wherein the transparent bonding layer is formed by spraying UV glue on the transparent base.

5. The oxidation-resistant glass-mounted photograph of claim 4, wherein the pattern layer is a 3D image and defines a plurality of pattern gaps therein, and the coating layer is filled into the pattern gaps.

6. The oxidation-resistant glass-mounted photograph of claim 3, wherein the coating layer is made of acrylic, titanium dioxide and additives, the coating layer is mixed at a predetermined proportion under room temperature.

7. The oxidation-resistant glass-mounted photograph of claim 6, wherein the additive comprises a dispersing agent, a defoaming agent, a photosensitizer and a light stabilizer.

8. The oxidation-resistant glass-mounted photograph of claim 6, wherein the predetermined proportion is a weight ratio of the acrylic, titanium dioxide, and additives, and the weight ratio between the acrylic, titanium dioxide, and additive is 65%˜75%, 15˜20%, 5˜15%, respectively.

9. A method for manufacturing an oxidation-resistant glass-mounted photograph, comprising:
providing a transparent base comprising a front surface and a rear surface opposite to the front surface;
providing a UV inkjet printer comprising a first spraying nozzle and a second spraying nozzle, the first spraying nozzle and the second nozzle being connected to different cartridges through pipelines, spraying a layer of UV glue on the rear surface to form a bonding layer using the first spraying nozzle;
transmitting an electronic file of the pattern layer into the UV inkjet printer; spraying a layer of UV ink on the bonding layer using the second spraying nozzle according to the electronic file of the pattern layer, and
curing the layer of UV ink to form the pattern layer.

10. The method of claim 9, wherein the UV inkjet printer further comprising a third spray nozzle, and after the step of printing the pattern layer on the bonding layer, further comprising step of printing a coating layer on the pattern layer via the third spray nozzle.

11. The method of claim 10, wherein the pattern layer is a 3D image and defines a plurality of pattern gaps therein, and the coating layer is filled into the pattern gaps.

12. The method of claim 11, wherein the coating layer is made of acrylic, titanium dioxide and additives, the coating layer is mixed at a predetermined proportion under room temperature.

13. The method of claim 12, wherein the additive comprises a dispersing agent, a defoaming agent, a photosensitizer and a light stabilizer.

14. The method of claim 13, wherein the predetermined proportion is a weight ratio of the acrylic, titanium dioxide, and additives, and the weight ratio between the acrylic, titanium dioxide, and additive is respectively 65%˜75%, 15˜20%, 5˜15%.

15. The method of claim 13, wherein the electronic file of the pattern layer is transmitted into the UV inkjet printer using blue tooth transmission, Wi-Fi transmission or USB transmission.

16. An glass-mounted photograph, comprising:
a transparent base comprising a front surface and a rear surface opposite to the front surface;
a bonding layer formed on the rear surface, and a pattern layer formed on the bonding layer; wherein the pattern layer is a UV ink layer.
